(19) United States
(12) Patent Application Publication
(10) Pub. No.: US 2022/0261618 A1
(43) Pub. Date: Aug. 18, 2022

(54) METHOD AND APPARATUS USING A GRAPH NEURAL NETWORK

(71) Applicant: Robert Bosch GmbH, Stuttgart (DE)

(72) Inventors: Victor Garcia Satorras, Amsterdam (NL); Emiel Hoogeboom, Amsterdam (NL); Max Welling, Bussum (NL)

(21) Appl. No.: 17/649,297

(22) Filed: Jan. 28, 2022

(30) Foreign Application Priority Data
Feb. 17, 2021 (DE) 10 2021 201 506.9

(51) Int. Cl. G06N 3/04; G06N 3/08

(52) U.S. Cl. CPC G06N 3/0481; G06N 3/088

(57) ABSTRACT

A computer-implemented method. The method includes: receiving or knowing an input graph that comprises nodes and associated multi-dimensional coordinates, and propagating the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer, and wherein an output graph is provided in an output section of the trained graph neural network.

### CROSS REFERENCE

The present application claims the benefit under 35 U.S.C. § 119 of German Patent Application No. DE 10 2021 201 506.9, filed on Feb. 17, 2021, which is expressly incorporated herein in its entirety.

### FIELD

The present invention relates to advancements in the field of graph neural networks.

### SUMMARY

Problems of the related art may be solved by a method and an apparatus in accordance with the present invention, and the use of the method or the apparatus according to present invention.

A first aspect of the present invention is directed to a computer-implemented method. In accordance with an example embodiment of the present invention, the method comprises: receiving or knowing an input graph that comprises nodes and associated multi-dimensional coordinates, and propagating the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer, and wherein an output graph is provided in an output section of the trained graph neural network.

Advantageously, taking into account the coordinate embeddings preserves equivariance to rotations and translations on the multi-dimensional coordinates that are associated with the nodes. Moreover, the provided neural network is computationally inexpensive, as expensive higher-order representations can be avoided. In addition, the neural network easily scales to higher-dimensional spaces and is not limited to equivariance on 2- or 3-dimensional spaces.

Therefore, not only the feature embeddings of the nodes are learned but also coordinate embedding associated with a respective node are taken into account. Furthermore, the graph neural network processes the coordinates in a translation and rotation equivariant way. As many data exhibit certain symmetries, the translation and rotation equivariant graph neural network can reduce the effort on data augmentation during training.

Exploiting the symmetries of the data using equivariant functions helps to improve the learning of feature embeddings of each node, which then influence the performance of the downstream applications making uses of the feature embeddings.

According to an advantageous example embodiment of the present invention, the propagating comprises: determining a plurality of edge embeddings based on the set of node embeddings and based on the coordinate embeddings associated with the set of node embeddings.

According to an advantageous example embodiment of the present invention, the determining of the respective one of the edge embeddings comprises: determining at least one metric, especially a scalar value, indicative of a relationship, especially a squared relative distance, between the coordinate embeddings of the set; and wherein the determining of the respective one of the plurality of edge embeddings is based, inter alia, on the at least one metric.

By taking into account the at least one metric, a measure for the relative distance between the set of coordinate embeddings is provided. By involving the at least one metric in the edge operation, the equivariance is achieved.

According to an advantageous example embodiment of the present invention, the method comprises: aggregating the plurality of edge embeddings to an aggregated edge embedding; and determining at least a part of the output tensor of the hidden layer, in particular the node embedding of the hidden layer, based on the aggregated edge embedding and based on the associated node embedding of the previous state.

According to an advantageous example embodiment of the present invention, the aggregating further comprises: determining at least one weighting factor based on the respective edge embedding, especially based on an output of a sigmoid function, which has the edge embedding as an input; and wherein the aggregating of the plurality of edge embeddings to an aggregated edge embedding is based on the weighting factor.

Advantageously, the provided aggregating step does not have a negative impact on the equivariance properties of the model since the aggregating operates on edge embeddings, which are already E invariant.

According to an advantageous example embodiment of the present invention, the method comprises: determining the coordinate embedding of at least one node of the at least one hidden layer based on the set of node embeddings of the previous layer and based on the edge embedding associated with the set.

Advantageously, the coordinate embeddings are updated in the hidden layer allowing the nodes to change their positions according to the determined coordinate embeddings. Furthermore, the functionality of GNNs is extended to learn the relative positions between nodes that can change over the time, e.g., molecular dynamics and dynamics of physical systems.

According to an advantageous example embodiment of the present invention, the determining of the coordinate embeddings is based on a distance, especially a relative distance, between the set of coordinate embeddings of the previous layer, the distance being weighted by a weight of the coordinate operation that depends on the edge embedding associated with the set of coordinate embeddings of the previous layer.

According to an advantageous example embodiment of the present invention, the coordinate embeddings remain constant throughout the propagating.

Advantageously, applications benefit, where the spatial position or other coordinates remain constant over time, like in simulations of molecules.

According to an advantageous example embodiment of the present invention, the method comprises: determining, via a velocity operation, a weighting factor associated with a velocity embedding of a previous layer based on the associated node embedding of the previous layer; determining a velocity embedding of the at least one hidden layer based on the weighting factor and based on a velocity embedding of the previous layer; and determining the coordinate embedding of the at least one hidden layer based on the determined velocity embedding and based on the coordinate embedding of the previous layer.

Advantageously, dynamic systems can be modeled when the velocity is considered in the coordinate update. Therefore, control systems, simulations of physical systems and models based on dynamics in reinforcement learning can be realized. The provided coordinate update outperforms equivariant or non-equivariant alternatives in terms of running time and data efficiency.

According to an advantageous example embodiment of the present invention, an encoder section of an autoencoder comprises the trained graph neural network.

Advantageously, the integration of the trained graph neural network in the encoder section provides a reduced reconstruction error.

According to an advantageous example embodiment of the present invention, the input graph comprises sensor data representing at least one sensor measurement from at least one sensor associated with a state of the physical system; the method comprising: determining control data for controlling at least one actor of the physical system based on the output graph.

According to a second aspect of the present invention, an apparatus is provided. In accordance with an example embodiment of the present invention, the apparatus comprises: receiving or knowing means (i.e., receiving or know device) for receiving or knowing an input graph that comprises nodes and associated multi-dimensional coordinates and propagating means (i.e., propagator) for propagating the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer, and wherein an output graph is provided in an output section of the trained graph neural network.

According to an advantageous example embodiment of the present invention, the apparatus comprises: an input interface to receive sensor data representing at least one sensor measurement from at least one sensor associated with a state of the physical system, wherein the input graph comprises the sensor data;

determining means (i.e., determining device) to determine control data for controlling at least one actor of the physical system based on the output graph; and an output interface for transmitting the control data.

### BRIEF DESCRIPTION OF THE DRAWINGS

FIG. 1 depicts schematically a graph neural network, in accordance with an example embodiment of the present invention.

FIG. 2 depicts schematically a part of a hidden layer of the graph neural network, in accordance with an example embodiment of the present invention.

FIG. 3 depicts schematically an edge operation, in accordance with an example embodiment of the present invention.

FIG. 4 depicts schematically an update procedure for coordinates, in accordance with an example embodiment of the present invention.

FIG. 5 depicts schematically an autoencoder, in accordance with an example embodiment of the present invention.

FIG. 6 depicts schematically depicts a physical system and a control unit, in accordance with an example embodiment of the present invention.

FIG. 7 depicts schematically a node operation, in accordance with an example embodiment of the present invention.

FIG. 8 depicts schematically a coordinate operation, in accordance with an example embodiment of the present invention.

### DETAILED DESCRIPTION OF EXAMPLE EMBODIMENTS

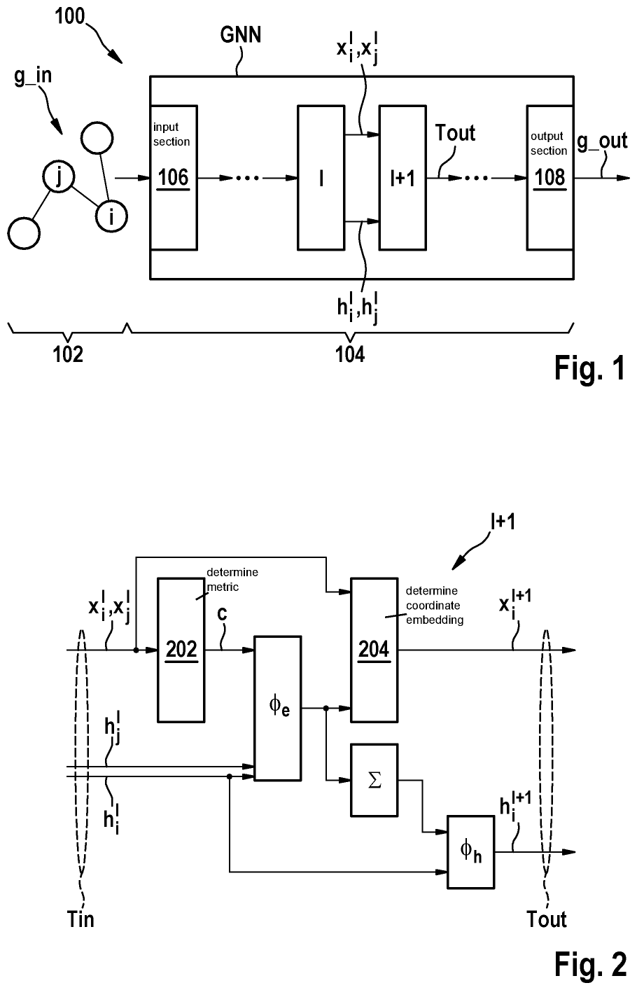

FIG. 1 depicts schematically a graph neural network GNN, especially an artificial trained graph neural network. Receiving means or knowing means (i.e., receiving or knowing device) 104 provide an input graph g_in that comprises nodes i, j and associated initial multi-dimensional coordinates. In particular, the input graph g_in comprises of a set of nodes v_i and edges e_ij, the respective node being associated with a feature embedding and a multi-dimensional coordinate. The message update equations formed by the proposed GNN ensure translation and rotation equivariance at the updates of the coordinates over the time, i.e., eq. (3).

Propagating means (i.e., propagator) 104 propagate the input graph g_in through the trained graph neural network GNN. The input graph g_in is provided as input to an input section 106 of the trained graph neural network GNN. An output tensor Tout of a node operation PHI_h, especially a perceptron or multilayer perceptron, of at least one hidden layer l+1 of the trained graph neural network GNN is determined, at least partly, based on a set or pair of node embeddings h\hat{ }l_i, h\hat{ }l_j of a previous layer l and based on coordinate embeddings x\hat{ }l_i, x\hat{ }l_j associated with the node embeddings h\hat{ }l_i, h\hat{ }l_j of the previous layer l. An output graph g out is provided in an output section 108 of the trained graph neural network GNN, especially based on the output tensor Tout.

The output tensor Tout comprises at least a feature embedding or node embedding h\hat{ }l+1_i, which is determined according to equation (6). The node operation PHI_h is based on the node embedding h\hat{ }l_i of the previous layer l and an aggregated edge embedding m_i.

Equation (6) performs the node operation PHI_h which takes as input the aggregated messages m_i, the node embedding h\hat{ }l_i and outputs the updated node embedding h\hat{ }+1_i for the hidden layer l+1.

Equivariance has proven its success in a variety of applications. Translation equivariance means that a translation of the input corresponds to an equivalent translation of the output feature map. This discards the need to do data augmentation reducing the computational resources in terms of training time and model capacity. Equivariance can also be found in other successful cases like permutation equivariance in Graph Neural Networks (GNNs). This GNN contributes a solution for translation and rotation equivariance.

The applications of the graph neural network GNN comprise: a computer-controlled machine, like a robot, a vehicle, a domestic appliance, a power tool, a manufacturing machine, a personal assistant or an access control system. The graph neural network GNN can be used to classify sensor data, detecting the presence of objects in the sensor data or perform a semantic segmentation on the sensor data, e.g. regarding traffic signs, road surfaces, pedestrians, vehicles. For the previous classification tasks, the GNN processes point clouds, e.g., LiDAR data. Apart from that, it can also be used for predicting molecular dynamics, dynamics of physical systems, e.g., N-body simulation, or potential links in social networking.

FIG. 2 depicts schematically a part of a hidden layer of the graph neural network, in particular a schematic block diagram of a part of the hidden layer l+1 of FIG. 1. The shown operations are directed to a node i of which the embedding of the hidden state l+1 is determined in view of another node j. An input tensor Tin, for a node i, comprises at a set or pair of node embeddings h\hat{ }l_i, h\hat{ }l_j and the associated coordinate embeddings x\hat{ }l_i, x\hat{ }l_j.

Determining 202 determines at least one metric c, especially a scalar value, indicative of a relationship, especially a squared relative distance x\hat{ }l_i, x\hat{ }l_j, between the coordinate embeddings of the set.

In line with equation (3), determining means (i.e., determining device) PHI_e, in particular a respective edge operation, determine a plurality of edge embeddings m_i,j based on the set of node embeddings h_i, h_j and based on the coordinate embeddings x_i, x_j associated with the set of node embeddings h_i, h_j. Determining means (determining device) PHI_e determine the respective one of the plurality of edge embeddings m_i,j based, inter alia, on the at least one metric c, for example the squared relative distance between two coordinate embeddings x\hat{ }l_i and x\hat{ }l_j. In equation (3), the relative squared distance between two coordinates serves as input for the edge operation PHI_e. The embeddings h\hat{ }l_i, h\hat{ }l_j, and the edge attributes a_ij are also provided as input to the edge operation.

m_{i,j}=ϕₑ(hᵢ^{l},hⱼ^{l},∥xᵢ^{l}−xⱼ^{l}∥²,aᵢⱼ) (3)

In line with equation (5), aggregating means (aggregator) Sigma aggregate the plurality of edge embeddings m_i,j to the aggregated edge embedding m_i. Equation (5) aggregates the incoming messages to node v_i.

$${m}_{i} = {\sum }_{j ∈ 𝒩 ( i )} {m}_{i , j} \qquad ( 5 )$$

Equations (3), (5) and 6 represent a graph convolutional layer, where h\hat{ }l_f is the nf-dimensional embedding of node v_i at layer 1. a_ij are the edge attributes. N(i) represents the set of neighbors of node v_i. Finally, φₑ, and φₕ are the edge and node operations respectively, which are approximated by multilayer perceptrons (MLPs).

According to an alternative example, in line with equation (8) the aggregating means (i.e., aggregator) Sigma further comprises: determining at least one weighting factor e_ij based on the respective edge embedding m_i,j, especially based on an output of a sigmoid function, which has the edge embedding m_i,j as an input; and wherein the aggregating Sigma of the plurality of edge embeddings m_i,j to an aggregated edge embedding m_i is based on the weighting factor e_ij.

$${m}_{i} = {\sum }_{j ∈ 𝒩 ( i )} {m}_{i , j} = {\sum }_{j \neq i} {e}_{ij} {m}_{i , j} \qquad ( 8 )$$

According to the right hand side of equation (8), e_ij takes the value 1 if there is an edge between nodes i, j and zero otherwise. Notice this does not modify yet the original equation used in our model; it is just a change in notation. Now we can choose to approximate the relations e_ij with the following function e_ij=φinf (m_ij), where φinf resembles a linear layer followed by a sigmoid function that takes as input the current edge embedding and outputs a soft estimation of its edge value. This modification does not change the E(n) properties of the model since we are only operating on the messages m_ij, which are already E(n) invariant. One can think of this as an invariant soft-attention function.

Determining means 204 determine the coordinate embedding x\hat{ }l+1_i of at least one node i of the at least one hidden layer l+1 based on the set or pair of node embeddings h\hat{ }l_i, h\hat{ }l_j of the previous layer l and based on the edge embedding m_i,j associated with the set.

Determining means PHI_h determine at least a part of the output tensor Tout of the hidden layer l+1, in particular the node embedding h\hat{ }+1_i of the hidden layer l+1, based on the aggregated edge embedding m_i and based on the associated node embedding h\hat{ }l_i of the previous state l.

The output tensor Tout comprises at least the node embedding h\hat{ }l+1_i of an associated node i and, optionally, the updated coordinate embedding x\hat{ }l+1_i.

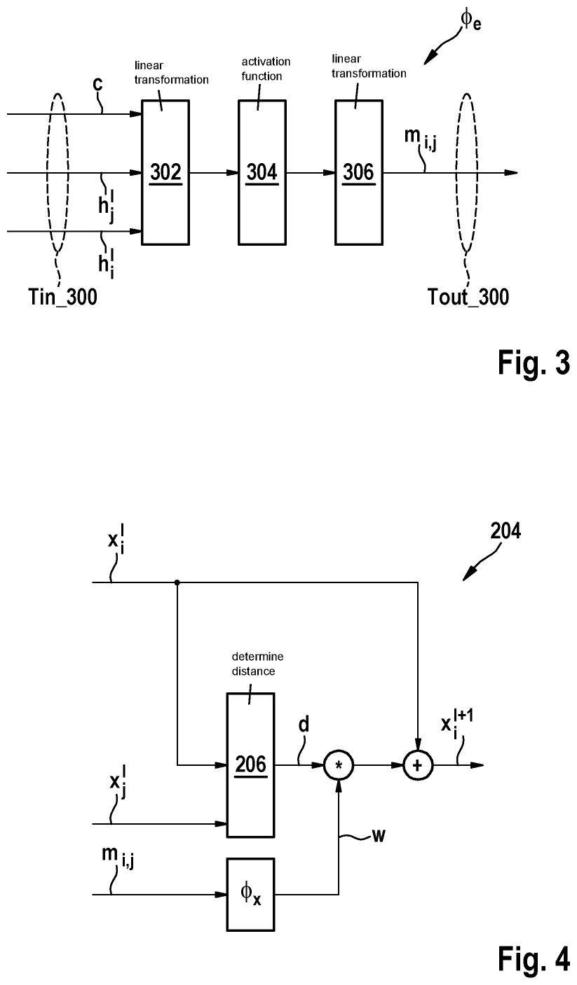

FIG. 3 depicts schematically an edge operation, in particular an example of the determining means PHI_e, for example an edge operation that comprises a multilayer perceptron, which comprises, in a cascaded order: a linear transformation 302 operating on an input tensor Tin_300, an activation function 304, and a linear transformation 306 for providing the output tensor T_out300.

FIG. 4 depicts schematically an update procedure for coordinates, in particular the determining means 204 of FIG. 2 in an exemplary schematic block diagram. The determining means 204 determine, in line with equation (4), the coordinate embeddings x\hat{ }l+1_i of the hidden layer l+1 based on a distance d, especially a relative distance, between the set of coordinate embeddings x\hat{ }l_i, x\hat{ }l_j of the previous layer l, the distance being weighted by a weight w of the coordinate operation PHI_x that depends on the edge embedding m_i,j associated with the set of coordinate embeddings x\hat{ }l of the previous layer l. The distance d is determined via determining means 206.

In other words, in equation (4) the position of each particle x_i is updated as a vector field in a radial direction. The position of each particle x_i is updated by the weighted sum of all relative differences (x_i−x_j) ∀j. The weights of the sum are provided as the output of the function PHI_x that takes as input the edge embedding m_i,j from the previous edge operation and outputs a scalar value. Equation (4) is the reason why translation and rotation equivariances are preserved. The embedding m_ij may carry information from the whole graph and not only from the given edge e_ij.

$${x}_{i}^{l + 1} = {x}_{i}^{l} + {\sum }_{j \neq i} ( {x}_{i}^{l} - {x}_{j}^{l} ) {ϕ}_{x} ( {m}_{i , j} ) \qquad ( 4 )$$

As an alternative to the determining means 204 of FIG. 4, the coordinate embeddings are not calculated. That is, the coordinate embeddings x\hat{ }l+1_i remain constant throughout the propagating 104.

According to an example for the constant coordinate embeddings, the input graph represents at least one molecule represented as a set of atoms, each atom having a 3D position and a five dimensional one-hot node embedding that describes the atom type (H, C, N, O, F). The input graph labels are a variety of chemical properties for each of the molecules, which are estimated through regression. These properties are invariant to translations, rotations and reflections applied to 3D coordinate embeddings. By skipping Equation (4) the proposed model becomes E(3) invariant. In this experiment, the GNN used Swish activation functions. A sum pooling operation followed by a linear layer maps all the node embeddings h from the last layer of the GNN to the estimated property value.

As an alternative to the determining means 204 of FIG. 4, equations (7) provides to take into consideration an initial velocity associated with a node.

$${v}_{i}^{l + 1} = {ϕ}_{υ} ( {h}_{i}^{l} ) {v}_{i}^{l} + {\sum }_{j \neq i} ( {x}_{i}^{l} - {x}_{j}^{l} ) {ϕ}_{x} ( {m}_{i , j} ) {x}_{i}^{l + 1} = {x}_{i}^{l} + {v}_{i}^{l + 1} \qquad ( 7 )$$

Accordingly, determining means are provided to determine, via a velocity operation PHI_v, a weighting factor associated with a velocity embedding v\hat{ }l_i of a previous layer l based on the associated node embedding h_i of the previous layer l.

Determining means are provided to determine a velocity embedding v\hat{ }l+1_i of the at least one hidden layer l+1 based on the weighting factor, based on a velocity embedding v\hat{ }l_i of the previous layer l, and based on the right-hand side summand/addend of equation (4). Determining means determine the coordinate embedding x\hat{ }l+1_i of the at least one hidden layer l based on the determined velocity embedding v\hat{ }l+1_i and based on the coordinate embedding x\hat{ }l_i of the previous layer l.

Therefore, equation (7) allows keeping track of the particle's momentum. In some scenarios this can be useful not only to obtain an estimate of the particle's velocity at every layer but also to provide an initial velocity value in those cases where it is not 0. Examples include dynamical systems, where a function defines the time dependency of a point or set of points in a geometrical space. Modelling the complex dynamics of these systems is crucial in a variety of applications such as control systems, simulations, etc.

The input tensor T in also comprises the velocity embedding v\hat{ }l_i of the previous layer l. The output tensor T_out further comprises the velocity embedding v\hat{ }l_i of the hidden layer l+1.

The velocity operation PHI_v maps the node embedding h\hat{ }l_i to a scalar value. Notice, that if the initial velocity is set to zero (v(0)=0), both equations (4) and (7) become the same for the first layer l=zero and they become equivalent for the next layers, since PHI_v re-scales all the outputs of PHI_x from the previous layers with a scalar value.

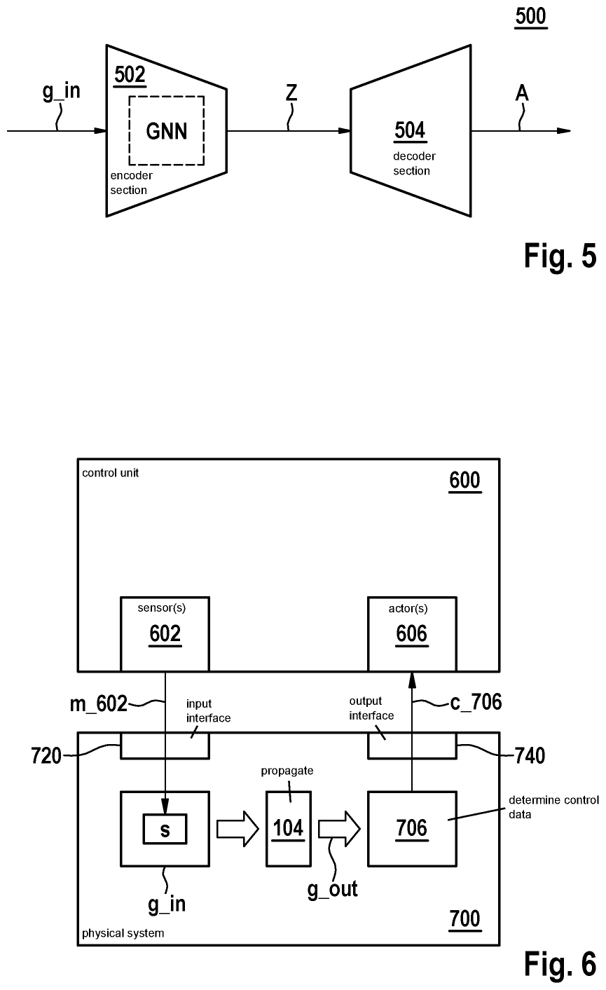

FIG. 5 depicts schematically an equivariant graph autoencoder 500 with an encoder section 502 and a decoder section 504. The encoder section 502 of an autoencoder 500 comprises the trained graph neural network GNN. The GNN is used to compress the input graph and encode graphs into continuous representations, which can ease further processing. The latent code z obtained by the encoder section 502 is used, for example, as a code word to represent the graph in a compact form.

The graph autoencoder 500 can learn unsupervised representations of graphs in a continuous latent space. The autoencoder 500 benefits from equivariance. The embedding space can be scaled to larger dimensions and is not limited to a three-dimensional (physical).

The latent code z as a representation of the graph is continuous and can be easily processed by the decoder section 504 comprising an artificial neural network for downstream applications.

According to an example, the decoder section 504 reconstructs an adjacency matrix A. The decoder g e of the decoder section 504 takes as input the embedding space z and outputs the reconstructed adjacency matrix A according to equation (9). w and b represent learnable parameters.

$${\hat{A}}_{ij} = {g}_{e} ( {z}_{i} , {z}_{j} ) = \frac{1}{1 + exp ( w {‖ {z}_{i} - {z}_{j} ‖}^{2} + b )} \qquad ( 9 )$$

The proposed GNN encodes the edges between nodes. Instead of contaminating the node features with random noise as in the related art, the provided GNN introduces a coordinate for each node. By encoding the coordinates along with the node features, the decoder section 504 successfully restores the edges in the graph, even if the graph has a symmetric structure.

According to an example, noise sampled from a Gaussian distribution is added to the input graph g_in, in particular to the input node embeddings of the graph h\hat{ }0 i. The added noise allows having different representations for the node embeddings such that the graph can be decoded. The provided GNN will remain translation and rotation equivariant to the noise.

FIG. 6 depicts schematically depicts a physical system 700 and a control unit 600. The physical system 700 is a computer-controlled machine, like a robot, a vehicle, a domestic appliance, a power tool, a manufacturing machine, a personal assistant or an access control system.

The control unit comprises an input interface 720 to receive sensor data s representing at least one sensor measurement from at least one sensor 602 associated with a state of the physical system 600.

The input graph g_in comprises the sensor data s or is determined via determining means 704 based on the sensor data s. For example, the determining means 704 is a mapping function mapping the sensor data s to the input graph g_in. For example, the determining means comprises a further artificial neural network.

The output graph g out could be applied to a classifier, which may comprise another artificial neural network, to classify the output graph g out. The classifier receives the output graph g out and determines at least one class of a plurality of classes. Therefore, the classifier provides to classify the sensor data s received for determining the graph g_in. Classifying the sensor data s comprises, for example, detecting the presence of objects in the sensor data s or perform a semantic segmentation on the sensor data, e.g. regarding traffic signs, road surfaces, pedestrians, other vehicles.

Determining means (i.e., determining device) 706 determine control data c 706 for controlling at least one actor 606 of the physical system 600 based on the output graph g out of the propagating means 104 or on the output of the classifier. An output interface 740 is configured to transmit the control data c 706. According to an embodiment the determining means 706 determines output information based on the output graph g out or based on the output of the classifier in order to present the output information to a human being.

According to an example, the physical system 600 is a vehicle like a road vehicle. The sensor data s comprises digital images origintation from a digital camera mounted at the front of the vehicle. The sensor data s comprises at least one of video images, radar, LiDAR, ultrasonic, motion, thermal images, or sonar images. Therefore, the sensor data s represent at least a part of the environment of the vehicle, wherein traffic signs, road surfaces, pedestrians, other vehicles are part of the former environment. The determining means 704 determine the input graph g_in based on the sensor data s. The determining means 104 processes the input graph g_in representing at least one point cloud, e.g., LiDAR data. According to an example, the determining means 706 transmits the output information to a human machine interface. According to another example, the determining means 706 controls, via the control signal c 706, at least one actor like speed control, brake, steering angle, etc. of the vehicle.

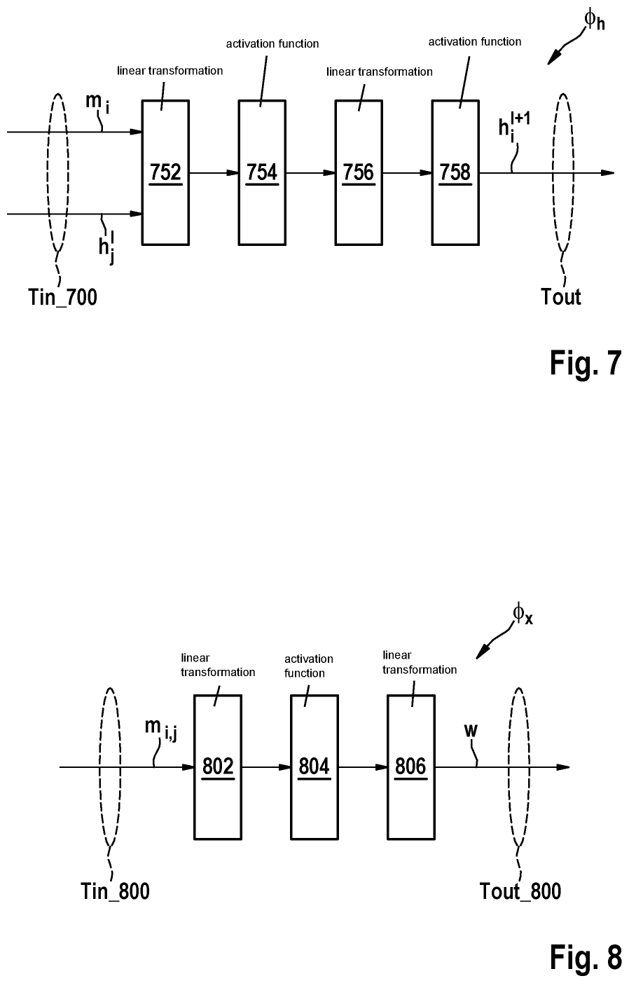

FIG. 7 depicts schematically a node operation PHI_h in an exemplary block diagram. According to an example, the node operation PHI_h comprises a multilayer perceptron, which comprises, in a cascaded order: a linear transformation 752 on the input tensor, an activation function 754, a linear transformation 756, and an activation function 758 for determining the output tensor.

FIG. 8 depicts schematically a coordinate operation, in particular the coordinate function PHI_x. According to an example, the coordinate operation PHI_x comprises a multilayer perceptron, which comprises, in a cascaded order: a linear transformation 802 operating on an input tensor Tin 800, an activation function 804, and a further linear transform 806 determining an output tensor Tout 800. A linear transform, in general, represents a linear layer that maps the hidden state to a scalar value, in other words, it is just a linear product.

What is claimed is:

1. A computer-implemented method, comprising:
receiving an input graph that includes nodes and associated multi-dimensional coordinates; and
propagating the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer; and
providing an output graph in an output section of the trained graph neural network.

2. The method according to claim 1, wherein the propagating includes:
determining a plurality of edge embeddings based on the set of node embeddings and based on the coordinate embeddings associated with the set of node embeddings.

3. The method according to claim 2, wherein the determining of a respective one the edge embeddings includes:
determining at least one metric indicative of a relationship between the coordinate embeddings associated of the set of node embeddings;
wherein the determining of the respective one of the plurality of edge embeddings is based on the at least one metric.

4. The method according to claim 3, wherein the metgric is a scalar value indicative of a squared relative distance between the coordinate embeddings of the set.

5. The method according to claim 2, further comprising:
aggregating the plurality of edge embeddings to an aggregated edge embedding; and
determining at least a part of the output tensor of the hidden layer based on the aggregated edge embedding and based on the associated node embedding of the previous layer.

6. The method according to claim 5, wherein the aggregating further includes:
determining at least one weighting factor based on each respective edge embedding;
wherein the aggregating of the plurality of edge embeddings to the aggregated edge embedding is based on the weighting factors.

7. The method according to claim 5, wherein the aggregating further includes:
determining at least one weighting factor based on outputs of a sigmoid function, which has each respective edge embedding as an input;
wherein the aggregating of the plurality of edge embeddings to the aggregated edge embedding is based on the weighting factors.

8. The method according to claim 2, further comprising:
determining a coordinate embedding of at least one node of the at least one hidden layer based on the set of node embeddings of the previous layer and based on the edge embedding associated with the set of node embeddings.

9. The method according to claim 8, wherein the determining of the coordinate embedding is based on a distance between the set of coordinate embeddings of the previous layer, the distance being weighted by a weight of a coordinate operation that depends on the edge embedding associated with the set of coordinate embeddings of the previous layer.

10. The method according to claim 2, wherein the coordinate embeddings remain constant throughout the propagating.

11. The method according to claim 2, further comprising:
determining, via a velocity operation, a weighting factor associated with a velocity embedding of the previous layer based on the associated node embedding of the previous layer;
determining a velocity embedding of the at least one hidden layer based on the weighting factor and based on a velocity embedding of the previous layer; and
determining a coordinate embedding of the at least one hidden layer based on the determined velocity embedding and based on a coordinate embedding of the previous layer.

12. The method according to claim 1, wherein an encoder section of an autoencoder includes the trained graph neural network.

13. The method according to claim 1, further comprising:
determining the input graph based on received sensor data representing at least one sensor measurement from at least one sensor associated with a state of a physical system.

14. The method according to claim 13, wherein the received sensor data include digital images, and wherein the physical system is a robot or a vehicle or a domestic appliance or a power tool or a manufacturing machine or a personal assistant or an access control system.

15. The method according 13, further comprising:
determining control data based on the output graph or based on a classification of the output graph; and
controlling at least one actor of the physical system based on the output graph.

16. An apparatus, comprising:
receiving device configured to receive an input graph that includes nodes and associated multi-dimensional coordinates; and
a propagator configured to propagate the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer, and wherein an output graph is provided in an output section of the trained graph neural network.

17. The apparatus according to claim 16, wherein the propagator is configured to determine a plurality of edge embeddings based on the set of node embeddings and based on the coordinate embeddings associated with the set of node embeddings.

18. A method comprising:
providing an apparatus, including:
receiving device configured to receive an input graph that includes nodes and associated multi-dimensional coordinates, and
a propagator configured to propagate the input graph through a trained graph neural network, the input graph being provided as input to an input section of the trained graph neural network, wherein an output tensor of at least one hidden layer of the trained graph neural network is determined, at least partly, based on a set of node embeddings of a previous layer and based on coordinate embeddings associated with the node embeddings of the previous layer, and wherein an output graph is provided in an output section of the trained graph neural network; and
using the apparatus.
